(19) United States
(12) Patent Application Publication
(10) Pub. No.: US 2022/0288771 A1
(43) Pub. Date: Sep. 15, 2022

(54) AN UNDERACTUATED SOFT ROBOTIC GRASPING DEVICE

(71) Applicant: Auckland Uniservices Limited, Auckland (NZ)

(72) Inventors: Lucas Ferrari Gerez, Auckland (NZ); Minas Liarokapis, Auckland (NZ)

(21) Appl. No.: 17/625,473

(22) PCT Filed: Jul. 23, 2020
(86) PCT No.: PCT/NZ2020/050073

§ 371 Date: Jan. 7, 2022

(30) Foreign Application Priority Data
Jul. 23, 2019 (NZ) 755669

(51) Int. Cl. B25J 9/10; B25J 15/00

(52) U.S. Cl. CPC B25J 9/102; B25J 9/104; B25J 15/0009

(57) ABSTRACT

A gear arrangement for actuating the fingers of a grasping device is disclosed. The gear arrangement distributes torque and/or rotational motion from a drive interface, such as an input gear or pulley, to three or more output shafts that are axially aligned. The gear arrangements can distribute torque and/or rotational motion to two output shafts that are axially aligned and co-extensive. These gear arrangements can utilise nested differentials, where the output from an outer differential is used as input to one or more inner differentials. The output from the differential is coupled to the fingers of a grasping device by a network of artificial tendons.

### BACKGROUND

The following includes information that may be useful in understanding the present inventions. It is not an admission that any of the information provided herein is prior art, or relevant, to the presently described or claimed inventions, or that any publication or document that is specifically or implicitly referenced is prior art. Any discussion of the prior art throughout the specification should in no way be considered as an admission that such prior art is widely known or forms part of the common general knowledge in the field.

Robotic grippers, actuated prosthetic hands and grip augmenting gloves are examples of soft robotic grasping devices that attempt to replicate, assist or enhance human manipulation and/or grip. Robotic grippers have been developed for a diverse range of applications, including fruit picking, vehicle assembly and material handling. There are two basic robotic gripper categories: vacuum grippers and actuated grippers (such as pneumatic, hydraulic and servo-electric grippers). Some actuated gripping systems can be used for other applications, such as prosthetic hands and grip augmenting gloves, where there is a tendency to mimic anthropomorphic features (i.e. humanlike characteristics).

Actuated prosthetic hands are intended to restore the form and function of a human hand. A partial hand prosthesis is used where the recipient has lost one or more fingers. A complete prosthesis is used when the recipient has lost an entire hand. Both types of prosthesis interface with the recipient in some way to translate the recipient's intentions into finger and/or hand movements. This can be achieved with mechanical systems that transfer force from another part of the recipient's body to the prosthesis (i.e. a body powered prosthesis), or via sensors (e.g. EMG sensors that control motorised systems).

Grip augmenting gloves are used to enhance the functionality of a recipient's hand. The gloves can be used to increase fatigue tolerance for demanding gripping tasks (e.g. repetitive or heavy work), help with rehabilitation (e.g. for stroke patients) and improve long term mobility and/or strength for recipients that suffer from degenerative neurological and/or musculoskeletal diseases (e.g. arthritis, Cerebral Palsy and Parkinson's Disease). These devices usually comprise artificial tendons (e.g. cable or pneumatic/hydraulic lines) that extend from some form of actuator to the fingertips of a glove. Actuation of the actuator pulls the fingers toward the palm of the hand, replicating the recipient's natural grip.

The form and function of a grasping device is often defined by its intended application. For example, grasping devices that are intended to replace or augment human hands are expected to be wearable (e.g. battery powered, lightweight and appropriately sized for the recipient), whereas grippers that are used for industrial assembly lines will often prioritise grasping and/or lifting force. The variance in design objectives can restrict or prevent the adoption of established gripping technologies for dissimilar applications, especially where the design constraints are not well aligned or divergent.

It is an object of the present invention to provide a grasping device comprising at least three fingers and a differential as herein described, or to go at least some way to addressing one or more of the deficiencies of existing technologies, and/or to provide a useful alternative to existing options, and/or to at least provide the public with a useful choice.

### SUMMARY

In an exemplary embodiment, there is a grasping device comprising an anthropomorphic hand or glove with at least three actuated fingers, and a differential that is configured to distribute torque from a motor amongst the at least three actuated fingers to actuate the at least three actuated fingers, wherein the differential is configured to balance the force applied by each of the at least three actuated fingers to an object being grasped.

In another exemplary embodiment, there is a grasping device comprising at least three fingers, and a differential that couples the at least three fingers to the output of a motor, wherein the differential is configured to distribute torque from the motor between the at least three fingers and independently conform each of the at least three fingers to the shape of an object being grasp.

In another exemplary embodiment, there is a grasping device comprising at least three fingers, and at least one wound artificial tendon for each of the at least three fingers, wherein the wound artificial tendons couple the at least three fingers to a motor, and the grasping device is configured to distribute torque from the motor to each of the wound artificial tendons in substantially even proportion.

Other objects, aspects, features and advantages of the present invention will become apparent from the following description. It should be understood, however, that the detailed description and the specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

Embodiments are described with reference to the accompanying drawings, wherein:

FIG. 1a is schematic view of a grip augmenting glove showing a sheathed cable tendon extending from a differential to the forefinger of the glove.

FIG. 1b is a schematic view of a grip augmenting glove showing the routing and termination of a cable tendon with the glove.

FIG. 2a is a schematic view of a grip augmenting glove showing five cable tendons extending to each finger of the glove.

FIG. 2b is a schematic view of a grip augmenting glove being used by a recipient to grasp a cylindrical object.

FIG. 3 is a perspective view of an exemplary gearset coupled from to an electric motor via a direct drive gear interface.

FIG. 4a is a perspective view of a fixed ratio carrier that forms part of an outer differential for a stacked differential gear train.

FIG. 4b is a perspective view of the fixed ratio carrier shown in FIG. 4a with two set of planetary gears housed within the carrier.

FIG. 5a is a perspective view of a single side differential that can be stacked with an outer differential to form a nested gearset.

FIG. 5b is a perspective view of the side differential shown in FIG. 5a with the planetary gears of an outer differential arranged about a shared sun/ring gear.

FIG. 6 is a perspective view of a fixed ratio carrier, including two sets of planetary gears, that forms part of the side differential shown in FIGS. 3a and 3b.

FIG. 7 is a perspective view showing the planetary gears, sun gears and nested output shafts of a unilateral differential.

FIG. 8a is a perspective view of a stacked gearset comprising two laterally offset side differentials coupled to the planetary gears of an outer differential.

FIG. 8b is a perspective view of the gearset shown in FIG. 8a with the carrier removed from one of the side differentials to expose the planetary gears, sun gears and nested output shafts of the side differential.

FIG. 8c is a perspective view of the gearset shown in FIG. 8a with the carrier removed from both of the side differentials.

### DETAILED DESCRIPTION

The technologies disclosed herein are generally applicable to soft robotic grasping devices, such as robotic grippers, actuated prosthetic hands and grip augmenting gloves. Detailed embodiments of the technology are presented for grip augmenting applications, but the technology can be applied to other adaptive gripping applications.

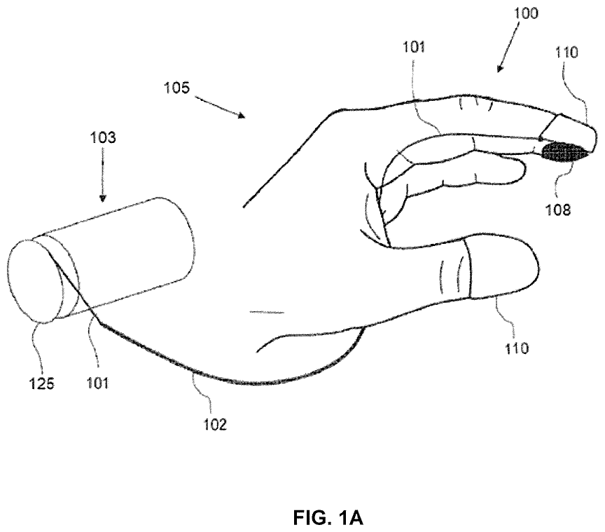

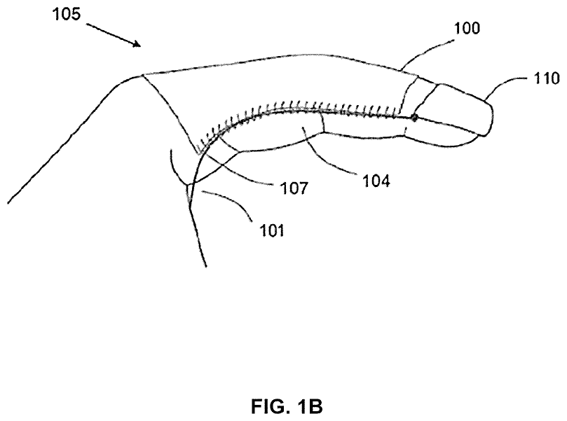

An exemplary grip augmentation system is shown schematically in FIG. 1a. The system comprises an actuated glove 105 that can be worn by a recipient to enhance grip strength. Torque is transferred from an electric motor 103 to the fingers 100 of the glove 105 by a network of artificial tendons. A single artificial tendon is shown in FIG. 1a. The depicted tendon comprises a sheathed cable 101 that extends from the actuator 103 to the tip of the forefinger 100. The distal end of the cable 101 terminates at the tip of the forefinger in a finger cap 110. The finger cap 110 anchors the tendon 101 to the glove and distributes forces from the tendon to the recipient's forefinger. The illustrated finger cap 110 also includes a sensor 108. The output from the sensor 108 is fed back to a controller that controls operation of the glove. For example, the controller can use the sensor 108 for touch detection, grip regulation and/or performance tracking (e.g. monitoring force distribution to each finger 110).

A proximal end of the cable 101 is wound about the drum of a pulley 125. The pulley 125 is driven by the electric motor 103 to tension the cable 101. The cable 101 transfers force from the electric motor 103 to the fingertip cap 110 of the glove 105 as it is progressively retracted and wound onto the drum of the pulley 125. The tension forces in the cable 101 cause the recipients finger to contract, folding inward toward the palm of the glove to augment the recipient's natural grip. A sheath 102 extends from the electric motor 103 to the base of the glove 105. The glove 105 and motor housing (not shown) have ferrules that locate and secure the sheath 102. The sheath 102 is sufficiently compression resistant to maintain a substantially constant cable path length between the electric motor 103 and glove 105 (e.g. preventing contraction of the cable path between the electric motor 103 and the glove 105). In some embodiments, the sheath can incorporate a low friction coating that reduces the sliding friction experienced by the cable.

An exemplary glove cable guide 107 is shown in FIG. 1b. The cable guide 107 restrains the cable 101 to a defined path within the glove 105. The illustrated cable guide 107 comprises a section of stitching that extends along an inner side of the forefinger 100. Another section of stitching (not shown in FIG. 1b) extends from the proximal end of the glove (e.g. adjacent the wrist or forearm) to the base of the palm. The cable 101 is unrestrained across the palm of the glove 105 in the embodiment illustrated in FIG. 1b. In other embodiments, the stitching can extend unimpeded between the base of the glove and the finger cap 110, or in discrete sections of different length/configuration. The cable guide 107 can incorporate a compliant liner that reduces cable friction within the glove 105. For example, a PTFE coated elastomeric tube can be used to route the cable 101 through the material of the glove 105 without restricting the recipient's mobility/flexibility. In the embodiment illustrated in FIG. 1b, the liner can be stitched into the fabric of the glove 105 at the forefinger 100 and extend unrestrained across the palm. The glove 105 can also incorporate a rigid or semi-rigid (e.g. thermoset plastic) palm guide to prevent or alleviate pressure induced cable friction (produced by the clamping forces from some forms of grip).

The fingertip terminated examples shown in FIGS. 1a and 1b cause the forefinger to bend in flexion. In some embodiments, flexion can be replaced or supplemented with other forms of anatomical motion. For example, the actuator 103 can cause adduction of the thumb by tensioning a cable 101 that terminates at the base of the thumb. The glove 105 can be reinforced at the base of the thumb (e.g. with a thermoplastic insert and/or reinforced loop around the thumb metacarpophalangeal joint) to anchor the cable 101, transfer forces to the thumb, and/or guide movement of the thumb in adduction. In some embodiments, the glove 105 can be configured to support multiple forms of anatomical motion. For example, thumb adduction can be used in combination with flexion of the thumb for some forms of grip. Independent adduction and flexion can be achieved with separate cables 101 that terminate at the base and tip of the thumb respectively.

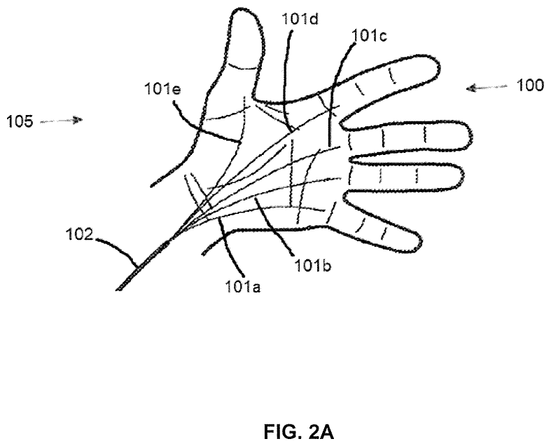

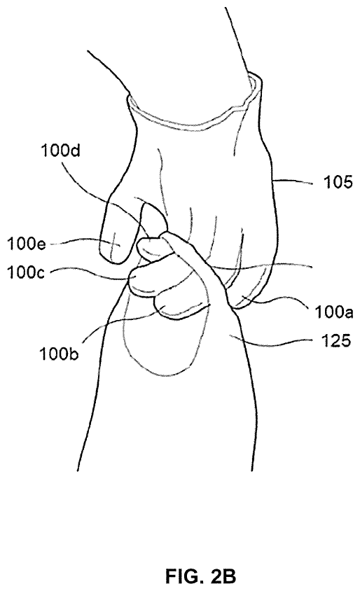

A grip augmenting glove 105 with five artificial tendons 101 is shown schematically in FIG. 2a. The tendons 101 extend from a sheath 102 at the base of the glove 105 and splay outwardly toward each of the five fingers 100. The glove fingers 100 have cable guides 107 that route the tendons 101 to a termination point (e.g. a finger cap) on each finger 100. The tendons 101 are actuated by one or more motors that apply and release tension as needed to affect an adequate grip. The sheath 102 routes the tendon cables 101 from the motor(s) to the base of the glove 105. For prosthetic hands and grip augmentation gloves, the motor(s) are usually housed in a wearable module that the recipient carries with them. For example, the motor module can be carried in a backpack, suspended from a belt that's worn around the waist, or held to the recipient's arm by an armband. The carrying mode for wearable systems is usually influenced by the weight and form-factor of the motor module. In some embodiments, the motor module also houses control electronics. The control electronics regulate the output of the motor(s) to modulate the grasping force applied by the glove 105. For example, the control electronics can incorporate one or more sensors (e.g. EMG and/or force sensors) that the control electronics that to infer recipient intent for force modulation and/or grip initiation.

FIG. 2b shows a grip augmenting glove 105 being used by a recipient to grasp a cylindrical object 130. In the illustrated embodiment, the artificial tendons 101 are applying a force to at least three of the fingers 100 (e.g. via a finger cap 110 on the corresponding finger). The combination of natural flexion and tendon tension causes the fingers 100 of the glove 105 to curl inwardly toward the palm of the recipient's hand, producing the cylindrical type grip shown in FIG. 2b. The force between the fingers and palm of the hand is representative of the grip strength. In some embodiments (e.g. rehabilitation), the glove 105 can be configured to replicate a healthy adult grip strength. In other embodiments (e.g. workplace specific tasks), the glove 105 can be configured to produce forces that exceed natural human grip strength.

The distribution of force to the fingers 100 of the glove 105 can influence the efficacy of the grasp the recipient forms. Grip stability is closely related to the contact area formed with an object. For gripping applications with well-defined constraints (e.g. robotic grippers for repetitive tasks), the force distribution to the fingers can be optimised for specific grip types (e.g. cylindrical, spherical or pinch grips). Adaptive grippers that conform to the shape of an object can be used for a diverse range of applications and are especially useful for grasping objects with irregular shape. Some embodiments of adaptive grip can be affected by distributing force to each of the actuated fingers in a way that doesn't impede their freedom of movement (i.e. actuating each finger to independently conform to the surface of the object). For under-actuated systems, this involves splitting the output from an actuator amongst several fingers without inhibiting their freedom of movement when one of the fingers is constrained (e.g. when one of the fingers contacts the surface of an object and stops moving).

Several exemplary gearsets are described for transferring torque and/or rotational motion to multiple outputs, such as the fingers of a soft robotic grasping device. The gearsets are typically coupled to a drive interface, such as a gear or pulley, which is driven via a suitable drive train, such as a chain, belt, shaft or gear, to impart torque and/or rotational movement to the gearset. In embodiments where the gearset functions as a differential, the rotational speed of the drive interface is proportional to the average rotational speed of the outputs. The output torque and/or rotational motion from the gearsets can be conveyed to other components, such as gears and pulleys, via output shafts. The exemplary gearsets are predominantly described in isolation—as independent mechanisms with distinct input(s) and output(s). However, the gearsets can also be used as subcomponents of larger gearing mechanisms, such as multifunctional gear trains for complex robotic gripping solutions. For example, the input and/or output of the gearset can be directly coupled to an intermediary stage of a larger gear train. While the gearsets are predominantly described for distributing torque and/or rotational motion from a single input to multiple outputs, it is also possible to use the gearsets in reverse, that is, to transfer torque and/or rotational motion from multiple inputs to a single output.

Some embodiments of the gearset can be employed as a torque splitter that distributes torque and/or rotational motion from an input, such as a gear or pulley, to multiple outputs that are axially aligned with the input (i.e. the outputs rotate about the same axis as the input). In some embodiments, the gearset comprises a unilateral differential with multiple concentric outputs that are co-extensive (i.e. two or more co-axial output shafts that extend in the same direction). Several unilateral differentials can be combined or stacked to distribute torque and/or rotational motion from one or more inputs to multiple outputs. The gearsets can employ spur gears, bevel gears, spiral bevel gears, helical gears, worm gears and/or other gear types to transfer torque and/or rotational motion to multiple concentric co-extensive output shafts. Some examples using epicyclic or planetary gear trains are described. Harmonic drive, ball differential, cycloidal drive and/or other gear trains can be used in addition to, or in place of, planetary gear trains for at least some applications.

In some embodiments, the exemplary gear arrangements distribute torque and/or rotational motion from a drive interface, such as an input gear or pulley, to three or more output shafts that are axially aligned. In other embodiments, the exemplary gear arrangements distribute torque and/or rotational motion, from an input, to two output shafts that are axially aligned and co-extensive. These gear arrangements can utilise nested differentials, where the output from an outer differential is used as input to one or more inner differentials. The gear arrangements can be configured to split torque from a motor evenly between the artificial tendons of a robotic grasping device to facilitate an adaptive grip. In some embodiments, the gearset comprises a differential with a drive interface, such as an input gear or pulley, and at least three output shafts that are axially aligned. It is often desirable to have an even number of output shafts to ensure that torque and/or stress is evenly distributed within the differential. But it is possible to transfer torque and/or rotational motion from a single input to an odd number of outputs. Ideally, each of the at least three output shafts can slip relative to the other of the at least three output shafts without the differential limiting slip between each of the at least three output shafts (i.e. the differential is non-locking). This permits each finger of a robotic grasping device to independently conform to the shape of an object, as each artificial tendon can be adjusted to a different length.

In certain embodiments, the differential comprises several stacked spur gear differentials. For example, the differential can comprise a first spur gear differential stacked with a second spur gear differential. In these embodiments the first spur gear differential includes the drive interface, and the second spur gear differential comprises two of the at least three output shafts. The output shafts from the second spur gear differential can extend unilaterally from the differential, so that two of the at least three output shafts extend in the same direction relative to the drive interface. One output from the first spur gear differential can be coupled to an input of the second spur gear differential, so that torque and/or rotation motion from the first spur gear differential is imparted to the second spur gear differential. In some embodiments, another output from the first spur gear differential can be coupled to the thumb of a prosthetic hand or grip augmenting glove, and the output shafts from the second spur gear differential can be coupled to the forefinger and middle finger to facilitate three finger adaptive grasping.

In some embodiments, the gearset comprises a series of stacked differential gearsets that are configured to transfer torque and/or rotational motion from the drive interface to four or more output shafts. The output shafts can be configured to tension the artificial tendons of a grasping device by winding a proximal end of the tendons about the drum of a pulley. In embodiments with three or more stacked differentials, the first differential gearset can comprise the drive interface, and at least two outputs. Subsequent gearsets can be coupled to an output of the first differential gearset to form a nested differential structure. For example, each output from the first differential gearset can be rigidly coupled to the carrier of a subsequent gearset. In this configuration, the first differential operates as an outer differential, and the subsequent differentials operate as inner differentials.

For embodiments comprising three stacked differentials, the second and third differential gearsets can each comprise two output shafts. The output shafts from these nested differential gearsets extend along a common axis (i.e. the differential comprises four axially aligned output shafts); with the output shafts from the second differential gearset extending in a first direction relative to the first differential gearset, and the output shafts from the third differential gearset extending in a second direction relative to the first differential gearset. Where the second and third differential gearsets are unilateral differentials, the second direction is preferably opposite to the first direction.

In some embodiments, the gearset comprises a torque splitter with an outer differential and two inner differentials. The inner differentials are nested with the outer differential to facilitate the transfer torque and/or rotation motion from the outer differential to the inner differential, or vice versa. Ideally the three differentials are aligned about a common axis. The inner differentials of the torque splitter can be coupled to distinct outputs of the outer differential. This configuration permits the inner differentials to slip relative to each other. And ideally, the outer differential doesn't limit slip between outputs (i.e. one inner differential can continue to convey rotational motion while the other is inner differential stationary). In these embodiments, the nested inner differentials of the torque splitter share at least one gear with the outer differential. For example, in embodiments that utilise planetary gearsets, the sun gear of the outer differential can be rigidly coupled to the carrier of an inner differential (i.e. the sun gear of the outer differential functions as the ring gear of the inner differential).

The torque splitter can be configured to conform the grip of an adaptive grasping device to the shape of an object. For example, the torque splitter can distribute torque in substantially even proportion between the actuated fingers of the device without inhibiting rotational motion of the differential output shafts (e.g. the differential is non-blocking), so that each finger independently conforms to the surface of the object. In at least some embodiments, the average rotational speed of the torque splitter output shafts is equivalent to the rotational speed of the drive interface, or a fixed multiple of the drive interface rotational speed.

Ideally, the inner differentials of the torque splitter are laterally offset from one another. That is, one of the inner differentials is disposed laterally to a first side of the outer differential, and the other inner differential is disposed laterally to the other side of the outer differential. In these embodiments, the torque splitter can utilize inner differentials with unilaterally extending output shafts. For example, each inner differential can have two output shafts that extend co-axially in the same direction, with the shafts from one inner differential extending to one side of the outer differential and the shafts from the other inner differential extending to the other side of the outer differential. In some embodiments, the output shafts from the two inner differentials can be aligned along a common axis. The outer differential can also be aligned with the same axis when a planetary gearset is used.

In some embodiments, the gearset comprises a differential with a drive interface, such as an input gear or pulley, and two axially aligned output shafts that are operationally coupled to the drive interface, and extend in the same direction relative to the drive interface. One of the output shafts can be nested within the other output shaft. This permits the differential to have co-extensive output shafts that are axially aligned. To facilitate nesting, one of the output shafts can have a hollow space that co-extends with the axis of the shaft, and the other output shafts extends through the hollow space. Where the two output shafts are concentrically arranged about a longitudinal axis, the inner shaft has a smaller outer diameter, and is axially longer, than the outer shaft. This means that the inner and outer shafts can experience different torsional loading, with the inner shaft being subjected to greater torsional stress than the outer shaft when both shafts have the same load conditions. In some embodiments, the drive interface has an axis of rotation that is aligned with the longitudinal axis of the output shafts. The drive interface can comprise an input gear or pulley that is configured to have a torque applied thereto. In some embodiments, the differential can be configured to distribute the torque applied to the input gear or pulley evenly amongst the two output shafts.

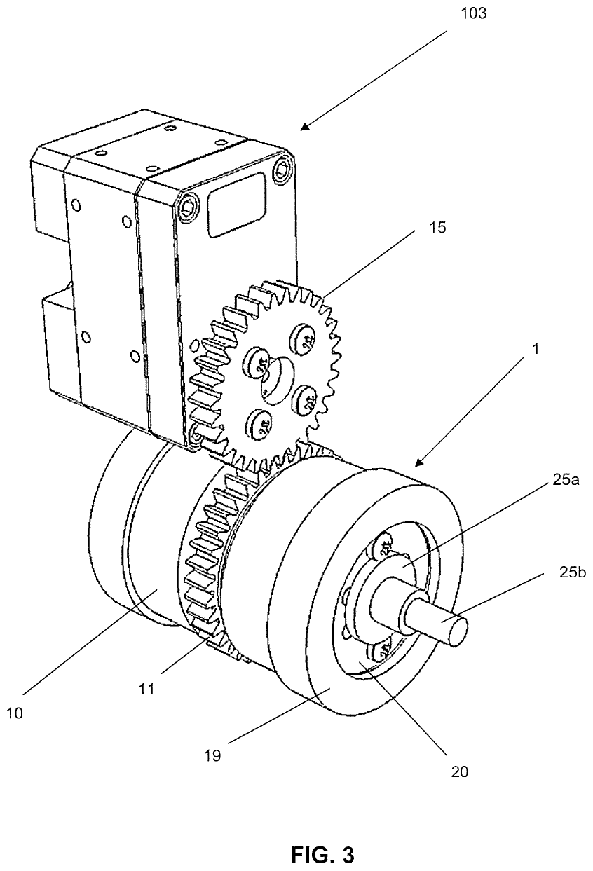

An exemplary gearset is shown in FIG. 3. The gearset 1 is configured to transfer torque and/or rotational motion from an actuator, in this case an electric motor 103, to multiple output shafts 25. The depicted gearset 1 functions as a differential or torque splitter, distributing torque from the electric motor 103 to four axially aligned output shafts 25. In other embodiments, the gearset 1 can be configured to transfer torque and/or rotational motion from multiple inputs to a single output, such as an electrical generator.

A drive interface transfers torque and/or rotational motion from the electric motor 103 to the gearset 1. In the embodiment illustrated in FIG. 3, a ring gear 11 is used as the drive interface for the gearset 1. Other drive interfaces, such as a belt and pulley or direct drive coupling, can also be used. The illustrated ring gear 11 is rigidly secured to an outer casing 10 of the gearset 1. A complimentary gear 15 on the electric motor 103 meshes with the ring gear 11 to transfer torque and/or rotational motion from the electric motor 103 to the outer casing 10 of the gearset 1

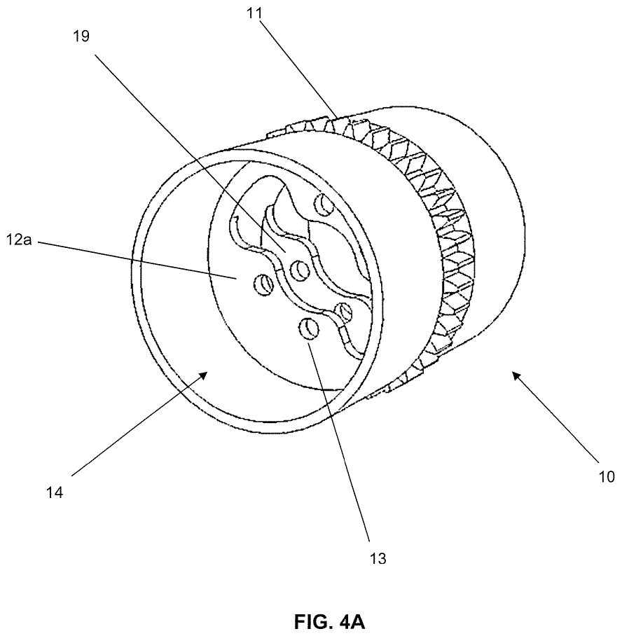

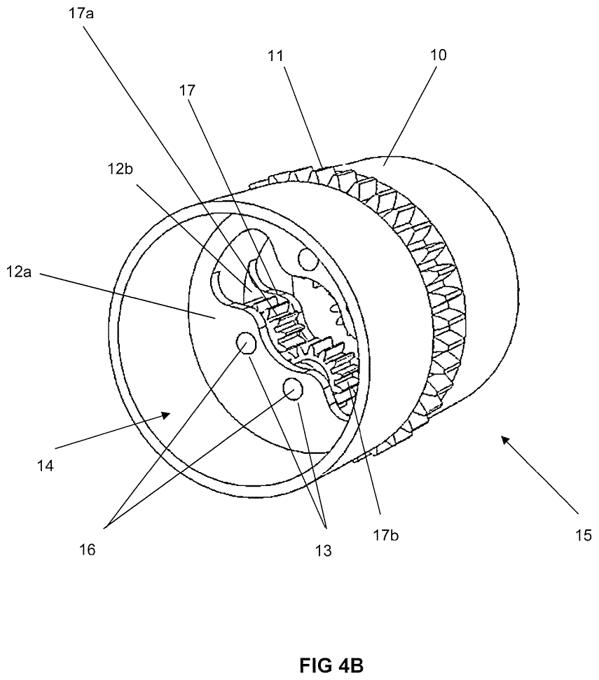

The outer casing 10 of the gearset 1 is shown in FIG. 4a. The ring gear 11 is integrally formed with the body of the illustrated casing 10. For example, the ring gear 11 can be machined or moulded with the rest of the casing 10 to form a monolithic component. In other embodiments, the drive interface can be separable from the casing 10 (e.g. by removing a set of bolts that secure the drive interface to the casing 10). The drive interface transfers rotational motion from the electric motor 103 to the casing 10, causing the casing 10 to rotate.

The casing 10 is configured to house sub-components of the gearset 1 and transfer torque and/or rotational motion from the drive interface to the sub-components. The depicted casing 10 is generally barrel shaped with an interior space 14 for sub-components. Two gear carriers 12 are disposed within the interior space 14 of the casing shown in FIG. 4a. The illustrated carriers 12 comprises a set of offset brackets 12a, 12b that are configured to support planetary gears. Each of the brackets 12a, 12b have a set of apertures 13 that align with complimentary apertures in the other bracket 12b, 12a of the carrier 12. These apertures 13 support the shafts of the planetary gears. For some applications, the brackets 12a, 12b of the carriers 12 can be fabricated from a low friction material, such as low friction polymer, that alleviates the need for bearings or bushings. For other applications, the carriers 12 are configured to incorporate bearings or bushings that support the shafts of the planetary gears.

FIG. 4b shows the casing 10 with a set of planetary gears 17 mounted to one of the carriers 12. The illustrated casing 10 is configured to house two equivalent planetary gearsets 17, 18. Each planetary gearset 17, 18 comprises two meshed gears that are secured to the casing 10 by a corresponding carrier 12. The casing 10 functions as a fixed carrier, holding the planetary gears 17, 18 relative to the ring gear 11. The depicted planetary gears 17 comprise a set of matched spur gears 17a, 17b. Each of the spur gears 17a, 17b is suspended within the casing 10 by a gear shaft 16. The gear shafts 16 are secured within the apertures 13 of the carrier brackets 12a, 12b. Each of the gears 17a, 17b is laterally offset from the centre of the carrier 12 so that the gears 17a, 17b only mesh along part of their length. For example, a bushing or stepped gear shaft can be used to axially space the gears 17a, 17b from one of the carrier brackets 12a, 12b. The gears 17a, 17b overlap in a central region either side of the carrier centreline. A lateral region of each gear 17a, 17b remains unmeshed with the other planetary gear 17b, 17a. The axial offset of the planetary gears 17a, 17b can be selected to control the amount of overlap. For example, the gears 17a, 17b can be configured to mesh for 25%, 30%, 35%, 40%, 45% 50%, 55%, 60%, 65%, 70% or 75% of their length.

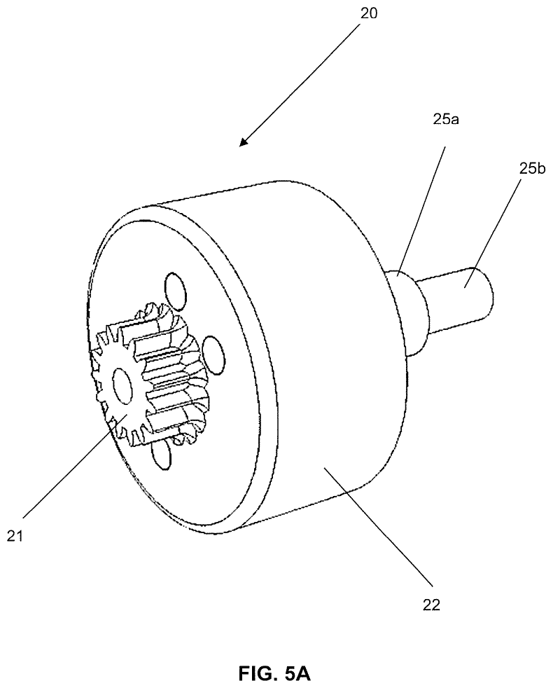

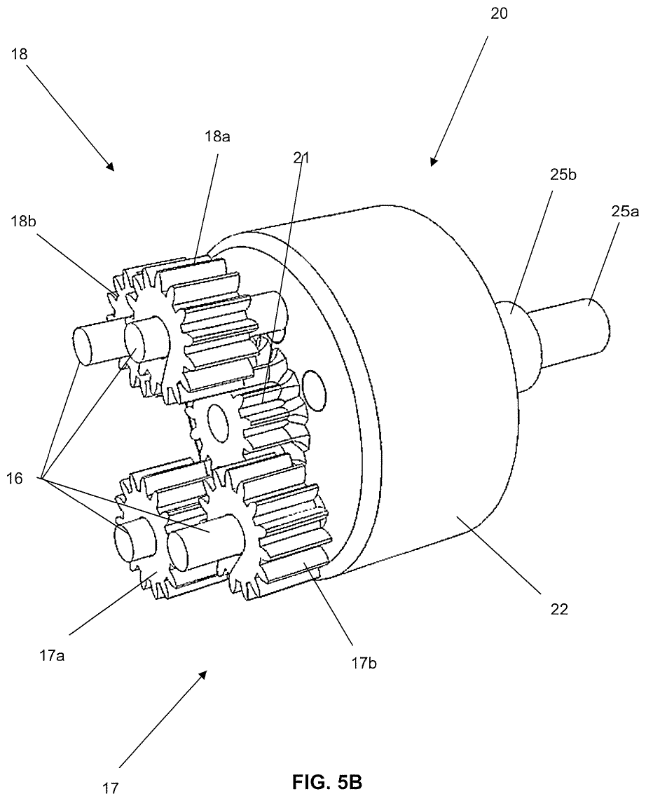

The outer casing 10, ring gear 11, gear carriers 12 and planetary gearsets 17, 18 shown in FIG. 4b form part of an outer differential 15. An inner differential, that is configured to nest with the outer differential 15, is shown in FIG. 5a. The inner differential 20 comprises an inner casing 22 that slots into the interior space 14 of the outer casing 10. The inner casing 22 is configured to sit to one side of the planetary gear carriers 12. The outer casing 10 can incorporate a bearing surface (such as a bushing, bearings, or low friction surface coating) that the inner differential 20 seats with to facilitate relative rotational motion of the inner casing 22 and outer casing 10.

A sun gear 21 functions as the drive interface for the inner differential 20. The sun gear 21 meshes with the planetary gears 17, 18 of the outer differential 15 to transfer torque and/or rotational motion to the inner differential 20. The outer differential 15 shares the sun gear 21 with inner differential 20 (i.e. the sun gear 21 forms part of the inner differential 20 and outer differential 15). The sun gear 21 illustrated in FIG. 5a is rigidly secured to the inner casing 22 of the inner differential 20 (e.g. the sun gear 21 and inner casing 22 form a monolithic component).

The gearset 1 shown in FIG. 3 comprises two inner differentials 20 that are nested with the outer differential 15. The inner differentials 20 are laterally offset on either side of the planetary gear carriers 12. For example, the first inner differential 20 can be positioned on the left side of the outer differential 15, and the second inner 20 differential can be position on the right side of the outer differential 15. The sun gear 21 of each inner differential 20 meshes with the lateral region of the corresponding planetary gears 17, 18 of the outer differential 15.

The outer casing 10 functions to align the inner differentials 15 with the outer differential. This ensures that the sun gear 21 of each inner differential 15 adequately engages with the planetary gearsets 17, 18 of the outer differential 20. In the embodiment shown in FIG. 3, the outer casing 10 also partially encapsulates the inner differentials 15. An end cap 19 fits over the outer casing 10 to enclose the circumferential gap between the inner differentials 20 and each of the outer differentials 15. The illustrated end caps 19 prevent debris entering the space between the outer casing 10 and inner casings 22. The end caps 19 can also be configured to as mounting structure for the outer casing 20. For example, the end caps can incorporate a bearing surface (such as a bushing, bearings, or low friction surface coating) that facilitates rotation of the outer casing 20 relative to an external structure (such as a housing or frame).

The inner differential 20 of FIG. 5a is shown engaged with the planetary gearsets 17, 18 of the outer differential 15 in FIG. 5b. The sun gear 21 is positioned at the centre of the planetary gearsets 17, 18. One planetary gear 17b, 18b from each of the planetary gearsets 17, 18 is offset to the same side of the casing 10 as the inner differential 20 shown in FIG. 5b. A lateral region of these planetary gears 17b, 18b meshes with the sun gear 21. The other planetary gears 17b, 18b shown in FIG. 5b are configured to mesh with a second inner differential that is laterally offset to the other side of the casing 10 (not shown in FIG. 5b). The planetary gears 17, 18 of the outer differential 15 are configured to transfer torque and/or rotational motion from the outer casing 10 to the sun gear 21 and casing 22 of the inner differential(s) 20.

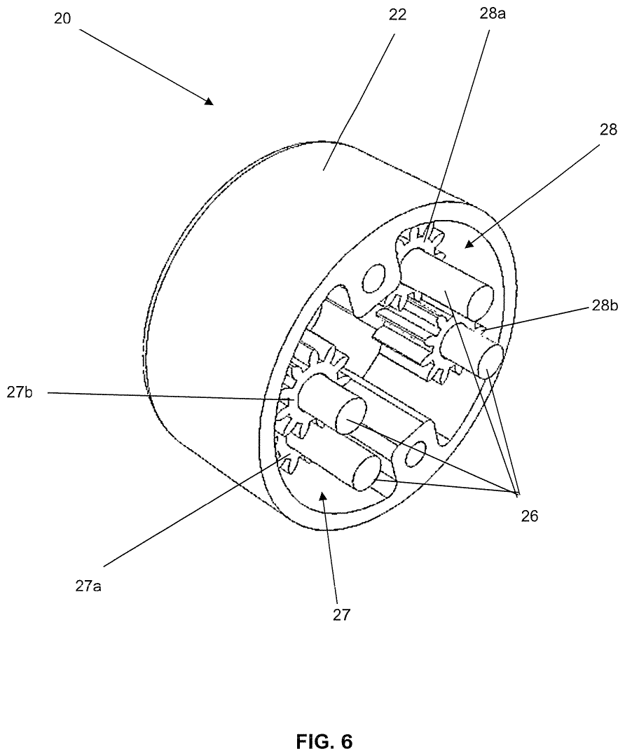

The inner casing 22 of the inner differential 20 functions as a carrier for a nested set of planetary gears 27, 28. The planetary gears 27, 28 are shown in FIG. 6 suspended within the inner casing 22 by gear shafts 26. The inner casing 22 is configured to transfer torque and/or rotational motion from the sun gear 21 to the nested planetary gears 27, 28 of the inner differential 20. In the embodiment shown in FIG. 6, the sun gear 21 operates as the drive interface for the planetary gearsets 27, 28 of the inner differential 20 (a functional equivalent of the outer differential ring gear 11), and the inner casing 22 functions as a fixed carrier, holding the planetary gears 27, 28 relative to the sun gear 21.

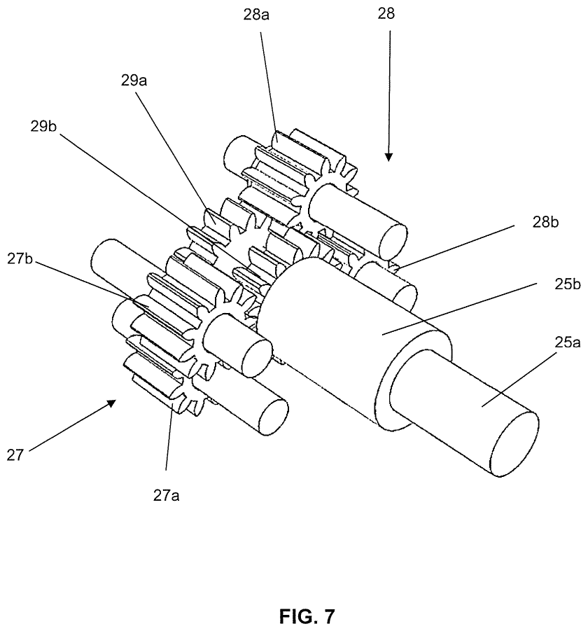

The planetary gears 27, 28 shown in FIG. 6 are configured to drive two axially aligned co-extensive output shafts. A set of exemplary output shafts 25 are shown in FIG. 7 engaged with the planetary gears 27, 28. The shafts 25 comprises a hollow outer shaft 25b and a solid inner shaft 25a. The inner shaft 25a extends through the hollow space in the outer shaft 25b. The outer shaft 25b necessarily has a greater diameter than the inner shaft 25a to accommodate the nested configuration shown in FIG. 7. In general, the inner diameter of the outer shaft 25b constrains the maximum outer diameter of the inner shaft 25a. For embodiments with more than two nested concentric shafts, the intermediate shafts (i.e. the shafts in the space bounded by the inner diameter of the outer shaft and the outer diameter of the inner shaft) are also hollow.

A bearing surface (such as a bushing, bearings or low friction surface coating) can be used to facilitate alignment and/or relative movement of the output shafts 25. For example, the distal end of each shaft 25a, 25b (i.e. the end not engaged with the planetary gears 27, 28) can be supported by a bushing that is configured to retain the shafts 25 in concentric alignment; and/or a needle bearing can be pressed into the hollow space of the outer shaft 25b, and the inner shaft 25a can be pressed into the inner race of the needle bearing. The output shafts 25 and bearing surface (if needed) can be scaled to match the intended application of the gearset. For example, larger diameter shafts 25 can be used for applications requiring greater torsional strength.

The output shafts 25a, 25b shown in FIG. 7 are each coupled to a sun gear 29a, 29b. The sun gears 29a, 29b are disposed near the proximal end of the output shafts 25a, 25b. The output shafts 25a, 25b and sun gears 29a, 29b can be integrally formed (e.g. welded, machined, moulded) or removably coupled (e.g. press fit, bolted, splined). The sun gears 29a, 29b sit at the centre of the planetary gears 27, 28 of the inner differential 20. A proximal planetary gear 27a, 28a from each planetary gearset 27, 28 meshes with the sun gear 29a of the inner shaft 25a. A distal planetary gear 27b, 28b from each planetary gearset 27, 28 meshes with the sun gear 29b of the outer shaft 25a. The sun gears 29a, 29b are axially offset to create space for the planetary gears 27, 28 to mesh. The proximal 27a, 28a and distal 27b, 28b planetary gears mesh in the gap between the sun gears 29a, 29b. The illustrated sun gears 29a, 29b are functionally equivalent (e.g. the sun gears 29a, 29b have the same number of teeth and pitch diameter). For some applications, non-equivalent sun gears can be used. For example, non-equivalent sun gears can be used to distribute torque disproportionately between the output shafts 25.

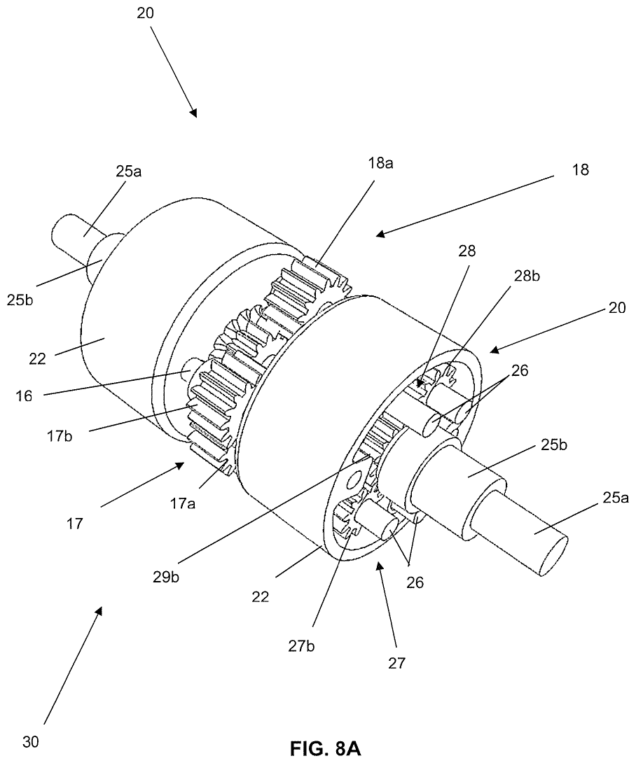

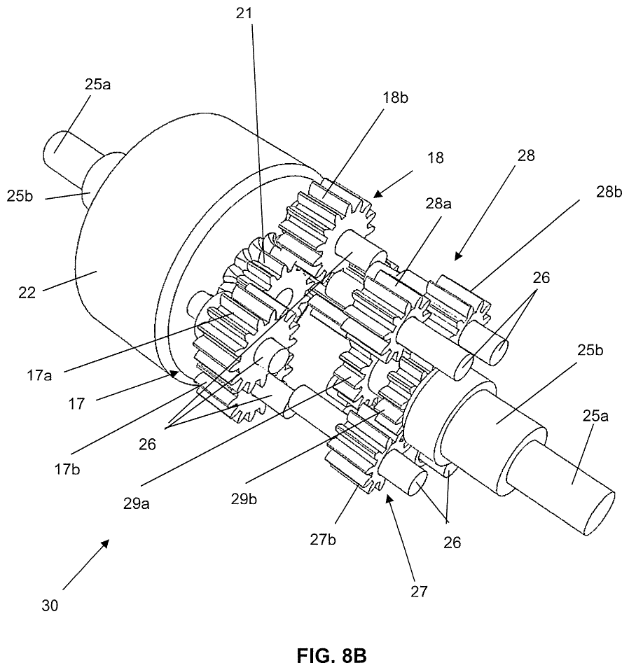

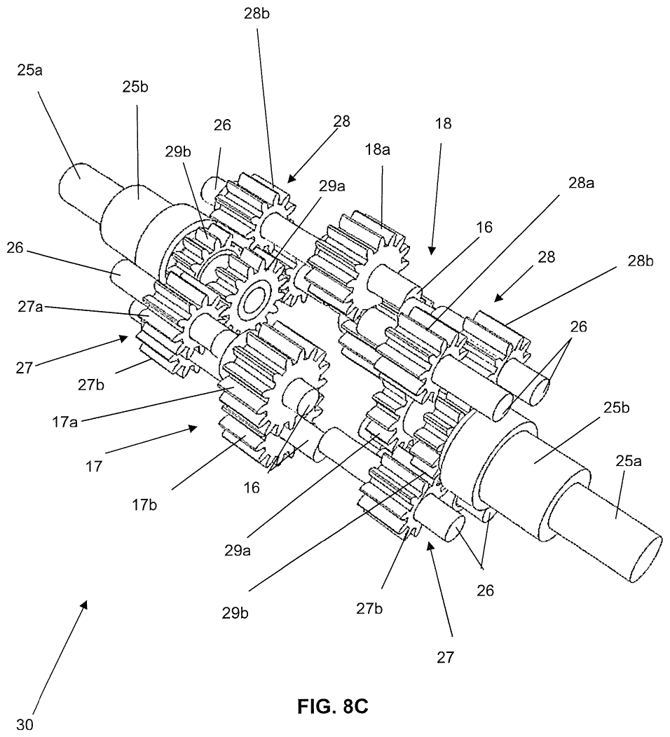

A torque splitter 30 comprising two nested inner differentials 20 is shown in FIG. 8a. The torque splitter 30 is depicted without an outer casing 10 and ring gear 11 in order to illustrate the interface between the outer planetary gears 17, 18 and inner differentials 20. The inner differentials 20 are laterally offset on either side of the outer planetary gears 17, 18. The sun gear 21 of each inner differential 20 meshes with a lateral region of the corresponding planetary gears 17, 18. The outer casing 10 of the torque splitter 30 functionally aligns the inner differentials 20 with the outer differential 15, ensuring that the sun gear 21 of each inner differential 15 adequately meshes with the corresponding planetary gears 17, 18.

The illustrated torque splitter 30 comprises four axially aligned output shafts. Each inner differential 20 has two concentric co-extensive output shafts 25 that extend laterally from the torque splitter 30. The output shafts 25 from the inner differentials 20 extend in opposite directions. For example, the output shafts from a first inner differential can extend to a right side of the torque splitter and the output shafts from the other inner differential can extend to a left side of the torque splitter. The output shafts 25 are driven via the gear train within the torque splitter when torque and/or rotational motion is applied to the drive interface (e.g. ring gear 11) of the outer differential 15. The torque splitter 30 can be configured to achieve a desired torque distribution between the four output shafts 25. For example, the gears at each stage of the torque splitter 30 depicted in FIG. 8a can be specified to produce a desired torque ratio between the output shafts.

The torque splitter 30 illustrated in FIG. 8a can be configured to distribute torque disproportionately between the four output shafts 25. For example, the outer differential 15 can distribute torque disproportionately between the two inner differentials 20 by employing non-equivalent outer sun gears 21 (and correspondingly disproportionate outer planetary gears 17, 18), and/or the inner differentials can distribute torque disproportionately between the co-extensive output shafts 25a, 25b by employing non-equivalent inner sun gears 29 (and correspondingly disproportionate inner planetary gears 27, 28). The torque splitter 30 can also be configured with laterally imbalanced outputs. For example, an output shaft and sun gear can be substituted for one of the inner differentials 20 (e.g. by rigidly coupling an output shaft to the inner casing 22 and sun gear 21) shown in FIG. 8a to produce a three output torque splitter. This directly couples one side of the outer differential 15 to an output of the torque splitter.

The torque splitter 30 is depicted in FIG. 8b with the gear train (e.g. inner planetary gears 27, 28 and sun gear 21) of one inner differential 20 exposed. The inner differential 20 is shown without a casing 22 (and corresponding sun gear 21), revealing the relative position of the inner gear train relative to the planetary gears 17, 18 of the outer differential 15. In the illustrated embodiment, torque is transferred from the drive interface (e.g. ring gear 11) to the outer planetary gears 17, 18 via the outer differential casing 10. The casing 10 functions as a fixed carrier for the outer planetary gears 17, 18. Torque applied to the drive interface causes the outer casing 10 to rotate and impart torque on the outer planetary gears 17, 18. The outer differential 15 transfers torque from the planetary gears 17, 18 to the inner differentials 20 via the outer sun gears 21. Rotation of the outer planetary gears 17, 18 causes the sun gears 21 to rotate. In the illustrated embodiment, the motion of each outer sun gears 21 is transferred directly to the corresponding inner differential casing 22. The inner differential casings 22 function as fixed carrier for the inner planetary gears 27, 28. Torque applied to the sun gear 21 causes the inner casing 22 to rotate and impart torque on the inner planetary gears 27, 28. The inner differentials 20 transfer torque from the planetary gears 27, 28 to the output shafts 25 via the inner sun gears 29. When the torque applied to one of the sun gears 29a, 29b exceeds the load on the corresponding output shaft 25a, 25b, the torque splitter 25 causes the output shaft 25, 25b to rotate.

The torque splitter 30 is depicted in FIG. 8c with the gear train (e.g. inner planetary gears 27, 28 and sun gear 21) of both inner differentials 20 exposed. The inner differentials 20 are shown without an inner casing 22 (and corresponding sun gear 21), revealing the position of the respective inner gear trains relative to the planetary gears 17, 18 of the outer differential 15. The proportion of torque distributed to each output shaft 25 is defined by the gear trains that link each output shaft 25 to the drive interface 11 of the outer differential 15 (i.e. the outer planetary gears 17, 18, outer sun gear 21, inner planetary gears 27, 28 and inner sun gear 29). The depicted torque splitter 30 is configured to distribute torque evenly between the four output shafts 25. In the illustrated embodiment, the gearing at each stage of the gear train is equivalent for each output shaft 25. The torque splitter 30 is configured to produce one quarter of the total input torque, applied at the drive interface 11 of the outer differential, at each of the output shafts 25 (assuming negligible losses in the torque splitter 30 gear train).

The torque splitter 30 is configured to control the tension in the artificial tendons 101 of a grasping device (such as the grip augmenting glove 105 shown in FIGS. 1 and 2). The artificial tendons 101 transform the rotational motion of the torque splitter 30 into movement of the fingers 100 of the grasping device. In some embodiments, the torque splitter 30 tensions the artificial tendons by winding them about the drum of a pulley. The grasping device is configured to convert the tension in the artificial tendons 101 into a grasping force at each of the fingers 100. The force causes the fingers 100 of the grasping device to fold inwardly toward the palm. To facilitate the efficient transmission of force to the fingers 100 of the grasping device, the artificial tendons 101 are ideally fabricated from a material with sufficient tensile strength and strain resistance to convey force from the torque splitter 30 to each of the fingers 100 of the grasping device. For example, a low friction braided fiber of high-performance UHMWPE (Ultra-High Molecular Weight Polyethylene) or braided stainless steel can be used for at least some applications.

The grasping device can be configured to apply substantially equal force to each of the actuated fingers 100. In some embodiments, this is achieved with appropriate gearing in the torque splitter 30 and equivalently sized output pulleys. For example, the torque splitter 30 can be configured to distribute torque from the motor 103 to each of the wound artificial tendons 101 in substantially even proportion by adopting nested differentials with equivalent epicyclic gearing (e.g. equivalent gearing in the stages of nested differentials shown in FIG. 8c). The size of the pulleys 125 that the artificial tendons 101 are wound on also influences the force experienced at the tip of the actuated fingers 101. This relationship is presented in Equations 1-5 for a grasping device with substantially equal force distribution to each actuated finger.

For an ideal torque splitter 30, the total torque applied from the motor is divided equally amongst the four output shafts 25 without loss. This relationship is represented by Equation 1.

τ_{d}=τ₁+τ₂+τ₃+τ₄ Equation 1

Where:
τ_{d}=the drive torque applied to the differential
τₙ=the torque on the n^{th} output shaft

Where the torque splitter 30 is configured to distribute torque to each of the wound artificial tendons 101 in substantially even proportion, the torque experienced at each output shaft is approximately the same. This relationship is represented in Equation 2:

τ₁=τ₂=τ₃=τ₄=τ_{d}/4 Equation 2

### Where:

τ_{d}=the drive torque applied to the differential
τₙ=the torque on the n^{th} output shaft

The output torque can be equated with the tension experience by the artificial tendons 101 (a tangential force on each of the output pulley) and the radius of the pulley 25. If the output pulleys 25 are all the same size, the tension in the artificial tendons 101 will be approximately equal.

This relationship is represented in Equation 3.

τₙ=Fₙrₙ Equation 3

### Where:

τₙ=the torque on the n^{th} output shaft
Fₙ=the tension experienced by the n^{th} artificial tendon
rₙ=the radius of the n^{th} output pulley

The output torque from the torque splitter 30 is proportional to the drive torque applied by the motor 103, and the gear ratio between the motor gear and the differential. This relationship is represented in Equation 4.

τ_{d}=i_{g}τₘ Equation 4

### Where:

τ_{d}=the drive torque applied to the differential
i_{g}=the gear ratio between the motor gear and the differential
τₘ=the torque produced by the motor

Ultimately, the tension in each artificial tendon of an ideal grasping device with substantially even torque distribution can be equated to the torque produced by the motor, the radius of the pulleys that the artificial tendons are wound about and the gear ratio between the motor and differential by combining Equations 2-4. This relationship is presented in Equation 5.

Fₙ=i_{g}τₘ/4rₙ Equation 5

### Where:

Fₙ=the tension experienced by the n^{th} artificial tendon
i_{g}=the gear ratio between the motor gear and the differential
τₘ=the torque produced by the motor
rₙ=the radius of the n^{th} output pulley

The distribution of torque and/or rotational motion from the motor 103 to each of the wound artificial tendons 101 can influence grip stability for some applications. For example, some specialised robotic grasping devices have a force distribution that is optimised for one grip type (such as pinch, lateral, spherical, tridigital or cylindrical). Grasping devices that distribute force in substantially even proportion amongst the grasping fingers 100, irrespective of the shape of the object being grasp, are often used for adaptive gripping because the grasping force is spread across the greatest surface area possible. The torque splitter 30 can be configured to distribute torque substantially evenly amongst the artificial tendons of four actuated fingers 100 (e.g. thumb, forefinger, middle finger and ring finger) of a grasping device.

For wearable grasping devices (e.g. prosthetic hands and grip augmenting gloves), grip formation and release is often initiated by the recipient of the device. For example, the filtered output from an EMG sensor that is positioned on the skin of the forearm where the myoelectric activations of the forearm muscles can be sensed (typically in the Flexor Digitorum Superficialis area) can be used to control the motor 103 through simple thresholding. In at least some embodiments of adaptive grasping devices, grip initiation causes all of the actuated fingers 100 to simultaneously contract inward toward the palm of the grasping device. When one of the actuated fingers 100 reaches the torque threshold of the system (e.g. exceeds the maximum torque output of the motor), it stops moving. This usually happens when the finger makes contact with an object. The torque splitter 30 then distributes the rotational motion from the motor 103 to the other actuated fingers 100. This causes the remaining actuated fingers to move faster (as the rotational speed of the motor remains unchanged) toward the surface of the object surface. Ultimately, the torque splitter 30 causes each actuated finger 100 to independently conform to the shape of the object. This promotes a robust grip that is object agnostic (i.e. the object does not need to conform to a predefined shape). The grasping device can also be configured to apply substantially the same grip force via each actuated finger.

In some embodiments, the grasping device comprises at least three fingers and a differential that couples the at least three fingers to the output of a motor. The differential can be configured to independently conform each of the at least three fingers to the shape of an object being grasp. For example, the differential can continue to distribute torque to the wound tendons of each finger irrespective of the whether the finger is moving (e.g. contracting inwardly) or not moving (e.g. in contact with the object). That is, the differential doesn't block or inhibit the movement of the fingers. Each of the at least three fingers can be exclusively coupled to one output of the differential. For example, the artificial tendon(s) for each finger extend to a single output of the differential. In some embodiments, the grasping device can comprise artificial tendons that connect each of the at least three fingers to more than one output shaft of the differential. The grasping device can comprise an even number of fingers, and the differential can be configured to distribute torque from the motor evenly between each of the fingers.

In some embodiments, the grasping device comprises at least four fingers and at least one wound artificial tendon for each of the at least four fingers. The wound artificial tendons couple the at least four fingers to a motor, and the grasping device is configured to distribute torque from the motor to each of the wound artificial tendons in substantially even proportion. The grasping device can be configured to independently conform each of the at least four fingers to the shape of an object being grasp. In some embodiments, the grasping comprises a torque splitter that couples the wound artificial tendons to the motor.

The term “and/or” can mean “and” or “or”.

As used in this specification, the words “comprise”, “comprises”, “comprising”, and similar words, are not to be interpreted in an exclusive or exhaustive sense. In other words, they are intended to mean “including, but not limited to”. When interpreting each statement in this specification that includes the term “comprise”, “comprises”, or “comprising”, features other than that or those prefaced by the term may also be present.

Any method detailed herein also corresponds to a disclosure of a device and/or system configured to execute one, or more, or all, of the method actions. Likewise, any disclosure of a device and/or system detailed herein corresponds to a method of making and/or using the device and/or system, including a method of using that device according to the functionality detailed herein. And any disclosure of a device and/or system detailed herein also corresponds to a disclosure of otherwise providing that device and/or system.

It should be noted that various changes and modifications to the presently preferred embodiments described herein will be apparent to those skilled in the art. Such changes and modifications may be made without departing from the spirit and scope of the invention and without diminishing its attendant advantages. It is therefore intended that such changes and modifications be included within the present invention.

Aspects of the invention have been described by way of example only, and it should be appreciated that variations, modifications and additions may be made without departing from the scope of the invention, for example when present the invention as defined in the indicative claims. Furthermore, where known equivalents exist to specific features, such equivalents are incorporated as if specifically referred in this specification. Thus, where in the foregoing description reference has been made to integers or components having known equivalents thereof, those integers are herein incorporated as if individually set forth.

The invention may also be said broadly to consist in the parts, elements and features referred to or indicated in the specification of the application, individually or collectively, in any or all combinations of two or more of said parts, elements or features.

In at least some exemplary embodiments, any feature disclosed herein can be utilized in combination with any other feature disclosed herein unless otherwise specified. Accordingly, exemplary embodiments include a medical device including one or more or all of the teachings detailed herein, in any combination. While various embodiments have been described, they have been presented by way of example only, and not limitation. Changes in form and/or detail can be made therein without departing from the invention.

1. A grasping device, comprising:
an anthropomorphic hand or glove with at least three actuated fingers, and
a differential that is configured to distribute torque from a motor amongst the at least three actuated fingers to actuate the at least three actuated fingers,
wherein the differential is configured to balance a force applied by each of the at least three actuated fingers to an object being grasped.

2. The grasping device of claim 1, further comprising:
a plurality of artificial tendons that connect the differential to the at least three actuated fingers, wherein the plurality of artificial tendons are configured to transfer forces from the differential to actuate the at least three actuated fingers, and wherein the differential is configured to balance a tension in the plurality of artificial tendons.

3. The grasping device of claim 2, wherein the differential comprises an even number of output pulleys, wherein each of the output pulleys is connected to one of the at least three actuated fingers by one of the plurality of artificial tendons, wherein the differential is configured to wind the artificial tendons to actuate the at least three actuated fingers, and wherein at least two of the pulleys are configured to actuate a same one of the at least three actuated fingers in different ways.

4. The grasping device of claim 1, wherein the grasping device is configured to actuate one of the at least three actuated fingers in both flexion and adduction, and wherein the grasping device is configured to actuate the other two fingers of the at least three actuated fingers in flexion only.

5. A grasping device, comprising:
at least three fingers, and
a differential that couples the at least three fingers to an output of a motor,
wherein the differential is configured to distribute torque from the motor between the at least three fingers and independently conform each of the at least three fingers to the shape of an object being grasp.

6. The grasping device of claim 5, wherein the differential comprises at least three output pulleys, and each of the at least three fingers is coupled to one of the at least three output pulleys by an artificial tendon.

7. The grasping device of claim 5, wherein the differential comprises at least three outputs, wherein each of the at least three outputs are configured to slip relative to each of the other of the at least three outputs, and wherein the differential does not limit slip between each of the at least three outputs.

8. The grasping device of claim 5, wherein the differential comprises a first spur gear differential stacked with a second spur gear differential.

9. The grasping device of claim 5, wherein the differential comprises a drive interface, and at least three output shafts, wherein the drive interface is configured to receive torque and/or rotational motion from a motor, and wherein each of the at least three output shafts is configured to transfer the torque and/or rotational motion to at least one artificial tendon, and wherein the drive interface and the at least three output shafts are axially aligned.

10. The grasping device of claim 5, wherein the differential comprises a drive interface and a plurality of output shafts, and wherein the differential comprises a transmission for distributing torque amongst the plurality of output shafts.

11. The grasping device of claim 5, wherein the differential comprises an outer differential, a first inner differential, and a second inner differential, wherein the outer differential encloses at least a portion of the first inner differential and the second inner differential.

12. A grasping device, comprising:
at least three fingers, and
at least one wound artificial tendon for each of the at least three fingers,
wherein the wound artificial tendons couple the at least three fingers to a motor, and wherein the grasping device is configured to distribute torque from the motor to each of the wound artificial tendons in substantially even proportion.

13. The grasping device of claim 12, wherein the grasping device is configured to actuate each of the at least three fingers in flexion, and independently conform each of the at least three fingers to a shape of an object being grasp.

14. The grasping device of claim 13, wherein the grasping device is configured to actuate one of the at least three fingers in adduction.

15. The grasping device of claim 12, wherein the grasping device comprises a torque splitter that couples the wound artificial tendons to the motor, and the torque splitter comprises three spur gear differentials.

16. The grasping device of claim 15, wherein at least one of the three spur gear differentials is nested within another one of the three spur gear differentials.

17. The grasping device of claim 15, wherein the torque splitter comprises four axially aligned output shafts, and the torque splitter is configured to distribute torque evenly amongst the four axially aligned output shafts.

18. The grasping device of claim 15, wherein the torque splitter comprises an outer differential and two inner differentials, wherein the outer differential shares at least one gear with each of the two inner differentials.

19. The grasping device of claim 18, wherein the outer differential comprises an outer casing and a set of outer planetary gears, and wherein each of the two inner differentials comprises an inner casing and a set of inner planetary gears, wherein each of the casings is configured as a fixed carrier for the respective set of planetary gears.

20. The grasping device of claim 12, wherein the grasping device comprises four fingers, and wherein the grasping device comprises means for distributing torque evenly to each of the four fingers.
